(19) United States
(12) Patent Application Publication
(10) Pub. No.: US 2005/0071405 A1
(43) Pub. Date: Mar. 31, 2005

(54) Method and structure for producing high performance linear algebra routines using level 3 prefetching for kernel routines

(75) Inventors: Fred Gehrung Gustavson, Briarcliff Manor, NY (US); John A. Gunnels, Mt. Kisco, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/671,889

(22) Filed: Sep. 29, 2003

(51) Int. Cl. G06F 7/38

(52) U.S. Cl. 708/446

(57) ABSTRACT

A method (and structure) for executing linear algebra subroutines includes, for an execution code controlling an operation of a floating point unit (FPU) performing a linear algebra subroutine execution, unrolling instructions to prefetch data into a cache providing data into the FPU. The unrolling causes the instructions to touch data anticipated for the linear algebra subroutine execution.

### CROSS-REFERENCE TO RELATED APPLICATIONS

The following seven Applications, including the present Application, are related:

1. U.S. patent application Ser. No. 10/___,___, filed on ______, to Gustavson et al., entitled “METHOD AND STRUCTURE FOR PRODUCING HIGH PERFORMANCE LINEAR ALGEBRA ROUTINES USING COMPOSITE BLOCKING BASED ON L1 CACHE SIZE”, having IBM Docket YOR920030010US1,

2. U.S. patent application Ser. No. 10/___,___, filed on ______, to Gustavson et al., entitled “METHOD AND STRUCTURE FOR PRODUCING HIGH PERFORMANCE LINEAR ALGEBRA ROUTINES USING A HYBRID FULL PACKED STORAGE FORMAT”, having IBM Docket YOR920030168US1,

3. U.S. patent application Ser. No. 10/___,___, filed on ______, to Gustavson et al., entitled “METHOD AND STRUCTURE FOR PRODUCING HIGH PERFORMANCE LINEAR ALGEBRA ROUTINES USING REGISTER BLOCK DATA FORMAT”, having IBM Docket YOR920030169US1,

4. U.S. patent application Ser. No. 10/___,___, filed on ______, to Gustavson et al., entitled “METHOD AND STRUCTURE FOR PRODUCING HIGH PERFORMANCE LINEAR ALGEBRA ROUTINES USING LEVEL 3 PREFETCHING FOR KERNEL ROUTINES”, having IBM Docket YOR920030170US1,

5. U.S. patent application Ser. No. 10/___,___, filed on ______, to Gustavson et al., entitled “METHOD AND STRUCTURE FOR PRODUCING HIGH PERFORMANCE LINEAR ALGEBRA ROUTINES USING PRELOADING OF FLOATING POINT REGISTERS”, having IBM Docket YOR920030171US1,

6. U.S. patent application Ser. No. 10/___,___, filed on ______, to Gustavson et al., entitled “METHOD AND STRUCTURE FOR PRODUCING HIGH PERFORMANCE LINEAR ALGEBRA ROUTINES USING A SELECTABLE ONE OF SIX POSSIBLE LEVEL 3 L1 KERNEL ROUTINES”, having IBM Docket YOR920030330US1, and

7. U.S. patent application Ser. No. 10/___,___, filed on ______, to Gustavson et al., entitled “METHOD AND STRUCTURE FOR PRODUCING HIGH PERFORMANCE LINEAR ALGEBRA ROUTINES USING STREAMING”, having IBM Docket YOR920030331US1, all assigned to the present assignee, and all incorporated herein by reference.

### BACKGROUND OF THE INVENTION

1. Field of the Invention

The present invention relates generally to techniques for improving performance for linear algebra routines, with special significance to optimizing the matrix multiplication process, as exemplarily implemented as improvements to the existing LAPACK (Linear Algebra PACKage) standard. More specifically, preloading techniques allow a steady and timely flow of matrix data into working registers.

2. Description of the Related Art

Scientific computing relies heavily on linear algebra. In fact, the whole field of engineering and scientific computing takes advantage of linear algebra for computations. Linear algebra routines are also used in games and graphics rendering.

Typically, these linear algebra routines reside in a math library of a computer system that utilizes one or more linear algebra routines as a part of its processing. Linear algebra is also heavily used in analytic methods that include applications such as supply chain management, as well as numeric data mining and economic methods and models.

A number of methods have been used to improve performance from new or existing computer architectures for linear algebra routines. However, because linear algebra permeates so many calculations and applications, a need continues to exist to optimize performance of matrix processing.

More specific to the technique of the present invention, it has been recognized by the present inventors that performance loss occurs for linear algebra processing when the data for processing has not been loaded into cache or working registers by the time the data is required for processing by the linear algebra processing subroutine.

### SUMMARY OF THE INVENTION

In view of the foregoing and other exempalry problems, drawbacks, and disadvantages of the conventional systems, it is, therefore, an exemplary feature of the present invention to provide a technique that improves performance for linear algebra routines.

It is another exemplary feature of the present invention to improve factorization routines which are key procedures of linear algebra matrix processing.

It is another exemplary feature of the present invention to provide more efficient techniques to access data in linear algebra routines.

In a first exemplary aspect of the present invention, described herein is a method (and structure) for executing linear algebra subroutines, including, for an execution code controlling an operation of a floating point unit (FPU) performing a linear algebra subroutine execution, unrolling instructions to prefetch data into a cache providing data into the FPU. The unrolling causes the instructions to touch data anticipated for the linear algebra subroutine execution.

In a second exemplary aspect of the present invention, also described herein is a signal-bearing medium tangibly embodying a program of machine-readable instructions executable by a digital processing apparatus to perform the method described above.

In a third exemplary aspect of the present invention, also described herein is a method of providing a service involving at least one of solving and applying a scientific/engineering problem, including at least one of: using a linear algebra software package that computes one or more matrix subroutines, wherein the linear algebra software package generates an execution code controlling an operation of a floating point unit (FPU) performing a linear algebra subroutine execution, unrolling instructions to prefetch data into a cache providing data into an L1 cache for providing data to the FPU, the unrolling causing the instructions to touch data anticipated for the linear algebra subroutine execution; providing a consultation for purpose of solving a scientific/engineering problem using the linear algebra software package; transmitting a result of the linear algebra software package on at least one of a network, a signal-bearing medium containing machine-readable data representing the result, and a printed version representing the result; and receiving a result of the linear algebra software package on at least one of a network, a signal-bearing medium containing machine-readable data representing the result, and a printed version representing the result.

### BRIEF DESCRIPTION OF THE DRAWINGS

The foregoing and other exemplary features, aspects and advantages will be better understood from the following detailed description of exemplary embodiments of the invention with reference to the drawings, in which:

FIG. 1 illustrates a matrix representation for an operation 100 exemplarily discussed herein;

FIG. 2 illustrates an exemplary hardware/information handling system 200 for incorporating the present invention therein;

FIG. 3 illustrates an exemplary Floating Point Unit (FPU) architecture 302 as might be used to incorporate the present invention;

FIG. 4 exemplarily illustrates in more detail the CPU 211 that might be used in a computer system 200 for the present invention, as including a cache 401; and

FIG. 5 illustrates an exemplary signal bearing medium 500 (e.g., storage medium) for storing steps of a program of a method according to the present invention;

### DETAILED DESCRIPTION OF EXEMPLARY EMBODIMENTS OF THE INVENTION

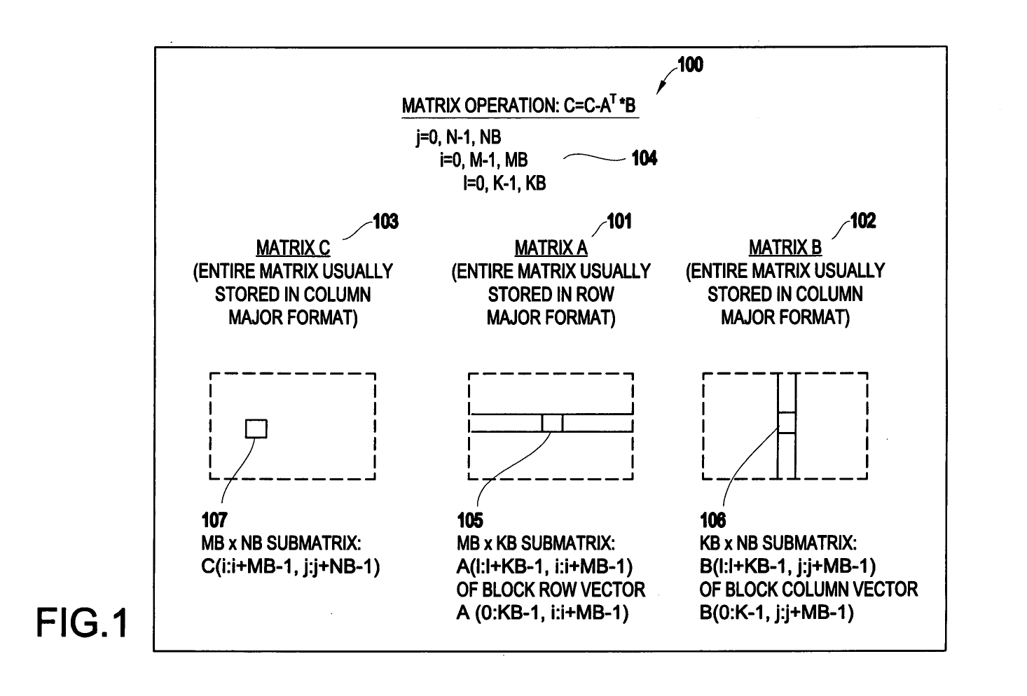

Referring now to the drawings, and more particularly to FIG. 1, an exemplary embodiment of the present invention will now be discussed. The present invention addresses, generally, efficiency in the calculations of linear algebra routines.

FIG. 1 illustrates processing of an exemplary matrix operation 100 (e.g., C=C−A^{T}*B). In processing this operation, matrix A is first transposed to form transpose-matrix-A (i.e., A^{T}) 101. Next, transposed matrix A^{T} is multiplied with matrix B 102 and then subtracted from matrix C 103. The computer program executing this matrix operation will achieve this operation using three loops 104 in which the element indices of the three matrices A, B, C will be varied in accordance with the desired operation.

That is, as shown in the lower section of FIG. 1, the inner loop and one step of the middle loop will cause indices to vary so that MB rows 105 of matrix A^{T} will multiply with NB columns 106 of matrix B. The index of the outer loop will cause the result of the register block row/column multiplications to then be subtracted from the MB-by-NB submatrix 107 of C to form the new submatrix 107 of C. FIG. 1 shows an exemplary “snapshot” during execution of one step of the middle loop i=i:i+MB−1 and all steps of the inner loop 1, with the outer loop j=j:j+NB−1.

In the above discussion, it is assumed that all of A^{T}, NB columns of B, and an MB×NB submatrix of C were simultaneously L1 cache resident. Initially, this will not be the case. In the present invention, it will be demonstrated that it is initially possible to bring all of A^{T} into the L1 cache during the processing of the first column swathes of B and C by the method called herein as “level 3 prefetching”.

A key idea is that, whenever there are significantly more floating point operations than load/store operations, it is possible to use the imbalance to issue additional load/store operations (touches) in order to overcome (almost completely) the initial cost of bringing matrix operands A^{T} and, later, pieces of (swathes) B and (submatrix blocks) C.

For purpose of discussion only, Level 3 BLAS (Basic Linear Algebra Subprograms) of the LAPACK (Linear Algebra PACKage) are used, but it is intended to be understood that the concepts discussed herein are easily extended to other linear algebra mathematical standards and math library modules.

In the present invention, a data prefetching technique is taught that lowers the cost of the initial loading of the matrix data into L1 cache for the Level 3 BLAS kernel routines.

However, before presenting the details of the present invention, the following general discussion provides a background of linear algebra subroutines and computer architecture as related to the terminology used herein.

Linear Algebra Subroutines

The explanation of the present invention includes reference to the computing standard called LAPACK (Linear Algebra PACKage) and to various subroutines contained therein. LAPACK is well known in the art and information is readily available on the Internet. When LAPACK is executed, the Basic Linear Algebra Subprograms (BLAS), unique for each computer architecture and provided by the computer vendor, are invoked. LAPACK comprises a number of factorization algorithms for linear algebra processing.

For example, Dense Linear Algebra Factorization Algorithms (DLAFAs) includes matrix multiply subroutine calls, such as Double-precision Generalized Matrix Multiply (DGEMM). At the core of level 3 Basic Linear Algebra Subprograms (BLAS) are “L1 kernel” routines which are constructed to operate at near the peak rate of the machine when all data operands are streamed through or reside in the L1 cache.

The most heavily used type of level 3 L1 DGEMM kernel is Double-precision A Transpose multiplied by B (DATB), that is, C=C−A^{T}*B, where A, B, and C are generic matrices or submatrices, and the symbology A^{T} means the transpose of matrix A (see FIG. 1). It is noted that DATB is the only such kernel employed by today's state of the art codes, although DATB is only one of six possible kernels.

The DATB kernel operates so as to keep the A operand matrix or submatrix resident in the L1 cache. Since A is transposed in this kernel, its dimensions are K1 by M1, where K1×M1 is roughly equal to the size of the L1. Matrix A can be viewed as being stored by row, since in Fortran, a non-transposed matrix is stored in column-major order and a transposed matrix is equivalent to a matrix stored in row-major order. Because of asymmetry (C is both read and written) K1 is usually made to be greater than M1, as this choice leads to superior performance.

Exemplary Computer Architecture

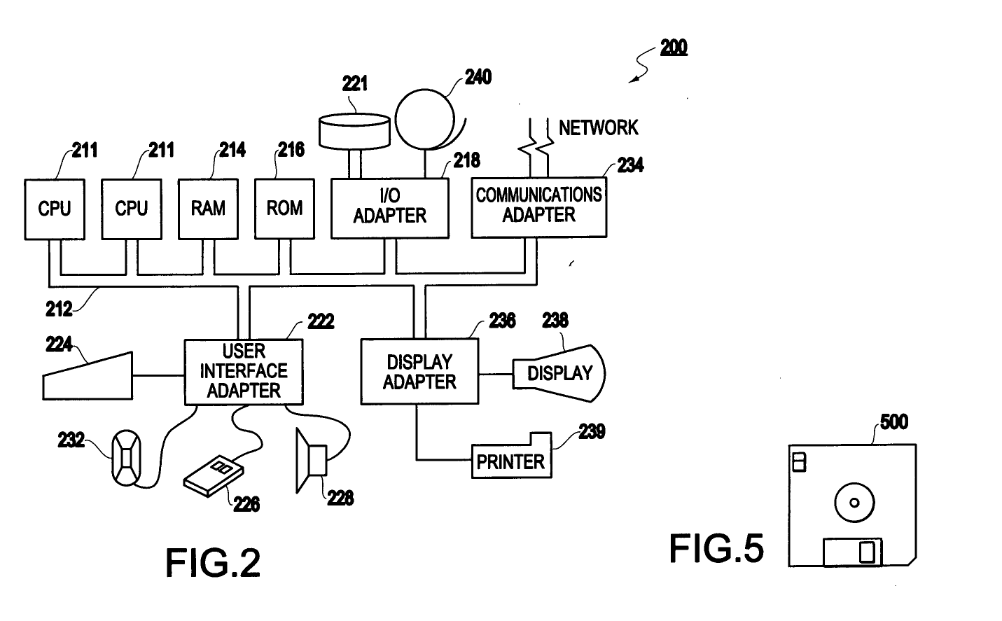

FIG. 2 shows a typical hardware configuration of an information handling/computer system 200 usable with the present invention. Computer system 200 preferably has at least one processor or central processing unit (CPU) 211. Any number of variations are possible for computer system 200, including various parallel processing architectures and architectures that incorporate one or more FPUs (floating-point units).

In the exemplary architecture of FIG. 2, the CPUs 211 are interconnected via a system bus 212 to a random access memory (RAM) 214, read-only memory (ROM) 216, input/output (I/O) adapter 218 (for connecting peripheral devices such as disk units 221 and tape drives 240 to the bus 212), user interface adapter 222 (for connecting a keyboard 224, mouse 226, speaker 228, microphone 232, and/or other user interface device to the bus 212), a communication adapter 234 for connecting an information handling system to a data processing network, the Internet, an Intranet, a personal area network (PAN), etc., and a display adapter 236 for connecting the bus 212 to a display device 238 and/or printer 239 (e.g., a digital printer or the like).

Although not specifically shown in FIG. 2, the CPU of the exemplary computer system could typically also include one or more floating-point units (FPUs) that performs floating-point calculations. Computers equipped with an FPU perform certain types of applications much faster than computers that lack one. For example, graphics applications are much faster with an FPU. An FPU might be a part of a CPU or might be located on a separate chip. Typical operations are floating point arithmetic, such as fused multiply/add (FMA), addition, subtraction, multiplication, division, square roots, etc.

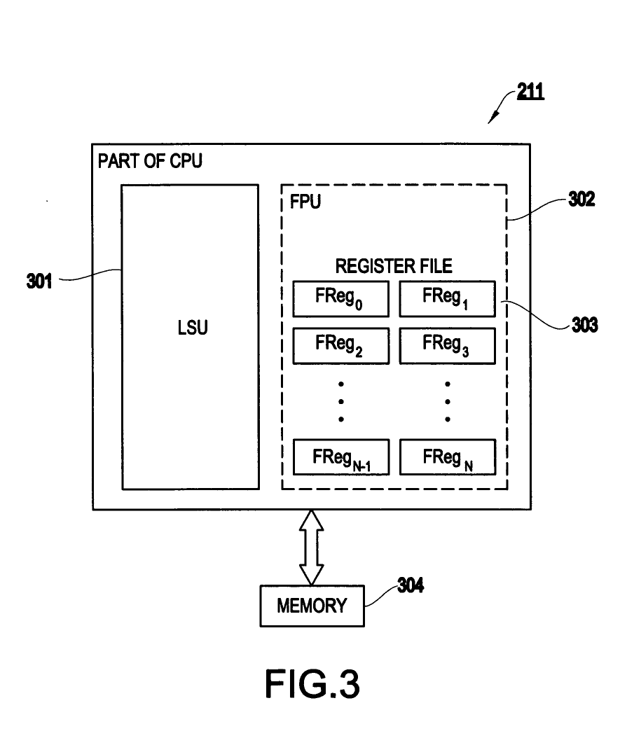

Details of the FPU are not so important for an understanding of the present invention, since a number of configurations are well known in the art. FIG. 3 shows an exemplary typical CPU 211 that includes at least one FPU 302. The FPU function of CPU 211 includes controlling the FMAs (floating-point multiply/add) and at least one load/store unit (LSU) 301, which loads/stores a number of floating point registers (FReg's) 303.

It is noted that, in the pretext of the present invention involving linear algebra processing, the term “FMA” can also be translated either as “fused multiply-add” operation/unit or as “floating-point multiply/add” operation/unit, and it is not important for the present discussion which translation is used. The role of the LSU 301 is to move data from a memory device 304 external to the CPU 211 to the FRegs 303 and to subsequently transfer the results of the FMAs back into memory device 304. It is important to recognize that the LSU function of loading/storing data into and out of the FRegs occurs in parallel with the FMA function.

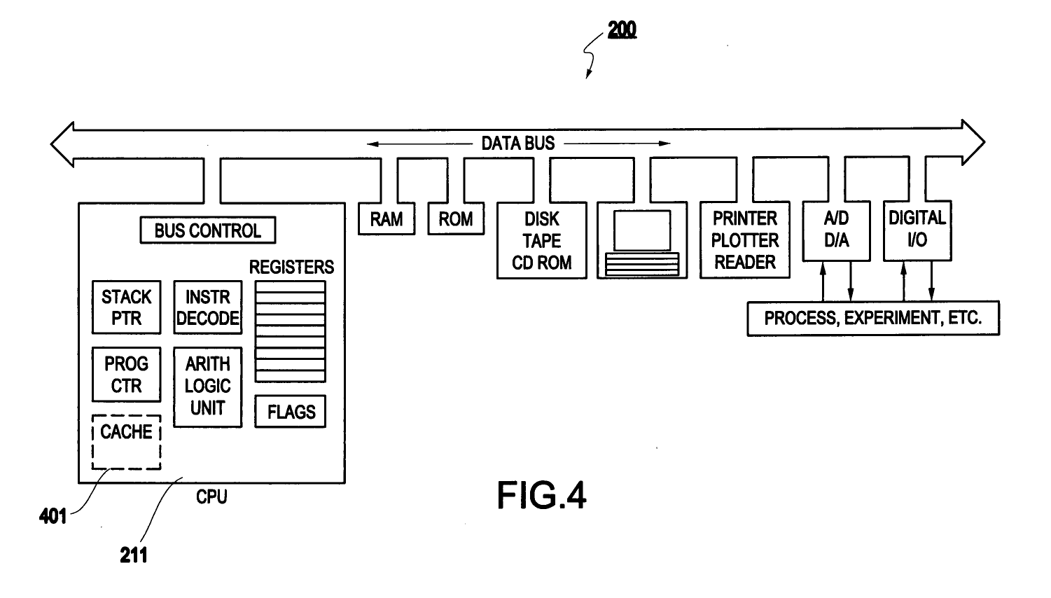

Another important aspect of the present invention relates to computer architecture that incorporates a memory hierarchy involving one or more cache memories. FIG. 4 shows in more detail how the computer system 200 might incorporate a cache 401 in the CPU 211.

Discussion of the present invention includes reference to levels of cache, and more specifically, level 1 cache (L1 cache), level 2 cache (L2 cache) and even level 3 cache (L3 cache). Level 1 cache is typically considered as being a cache that is closest to the CPU and might even be included as a component of the CPU, as shown in FIG. 4. A level 2 (and higher-level) cache is typically considered as being cache outside the CPU.

The details of the cache structure and the precise location of the cache levels are not so important to the present invention so much as recognizing that memory is hierarchical in nature in modern computer architectures, and that matrix computation can be enhanced considerably by modifying the processing of matrix subroutines to include considerations of the memory hierarchy.

Additionally, in the present invention, it is preferable that the matrix data be laid out contiguously in memory in “stride one” form. “Stride one” means that the data is preferably contiguously arranged in memory to honor double-word boundaries and the useable data is retrieved in increments of the line size.

Level 3 Prefetching of Kernel Routines

The present invention lowers the cost of the initial, requisite loading of data into the L1 cache for use by Level 3 kernel routines in which the number of operation steps are of the order n³. It is noted that the description “Level 3,”, in referring to matrix kernels discussed herein, means that the kernel (subroutine) involves three loops, e.g., loops i,j,k. That is, as shown in FIG. 1, in which exemplarily the kernel is executing the DGEMM operation C=C−A^{T}*B, an improvement in execution time can be achieved by reducing the memory lag for loading data to be used in the kernel routine.

In summary, the present invention takes advantage of the realization that a Level 3 kernel routine will require an order of n³ processing operations on matrices of size n×n, since there will be three FOR loops executing the operations on the matrices A, B, C, but that the number of operations to load a matrix of size n×n into cache is only of the order n². The difference (n³−n²) in the number of execution operations versus the number of loading operations allows for the prefetching of the data for the kernel routines.

It is sufficient to describe the implementation of the present invention as it relates to the BLAS Level 3 DGEMM L1 cache kernel. This is true both because the approach presented here extends easily to the other Level 3 BLAS and matrix operation routines and because those routines can be written in a manner such that their performance (and, thus, memory movement) characteristics are dictated by the underlying DGEMM kernel upon which they can be based.

As shown in FIG. 1, in the DGEMM kernel, there are three matrix operands: C, A, and B. The following assumes that the data (e.g., the contents of the matrices) is stored in Fortran format (i.e., column-major) and that it is desired to carry out the DGEMM operation C=C−A^{T}*B. Accordingly, this corresponds to storing A by rows and carrying out C=C−A^{T}*B.

It is important to mention the exact nature of the DGEMM kernel, as this kernel evinces stride-one access for both the A and B operands. Stride-one accesses tend to be faster, across platforms, for common architectural reasons. As can be seen from this last equation, A and B are the two most frequently accessed arrays.

A specific implementation of the DGEMM kernel will now be considered with specific ordering of the i, j, l loops, but the following principles apply to all such loop orderings.

The guiding principle is “functional parallelism”. That is, the load/store unit(s) (LSUs) and the FPU(s) can be considered to be independent processes/processors. They are “balanced” insofar as a single LSU can supply the registers of a single FPU with data at a rate of one data unit per cycle.

FIG. 1 shows matrix C as being an M×N matrix, matrix A as being an M×K matrix (or A^{T} stored in row major format), and matrix B as being a K×N matrix. The Average Latency of a load will be denoted as LA.

Because the LSU and FPU are balanced, the number of operations (M*N *K flops) by the FPU are greater than or equal to the number (MN+KM+KN) of load/store operations by the LSU. Therefore, for this sort of prefetching to yield a benefit:
(M*N*K)/((MN+KM+KN)LA) [symbol] 1.

Thus, multiplying the left side of the inequality by 1=1/(M*N*K)÷1/(M*N*K) yields:
1/(LA*(1/K+1/N+1/M)) [symbol] 1.

Dimension N will be defined as the streaming dimension. “Streaming” is the concept in which one matrix is considered resident in the L1 cache and the remaining two matrix operands (called “streaming matrices”) reside in the next higher memory level(s), e.g., L2 and L3. The streaming dimension is typically large.

Therefore, since 1/N→0, as N→∞:
1/(LA*(1/K+1/M)) [symbol] 1, or
LA*(1/K+1/M)≦1.

There are three matrices A, B, C to be prefetched using the guiding principle. FIG. 1 illustrates the case wherein A is the L1 cache resident matrix (i.e., in L1). Therefore, the DGEMM kernel subroutine DATB will need:
a) “All” of A^{T}(an almost L1-sized block). For consideration of the kernel operands only, the matrix size M*K elements will suffice.
b) A column swath of B (K*NB elements).
c) A register block of C (MB*NB elements).

The guiding principles as they apply to matrices A, B, C in a), b), and c) above will now be exercised below in (1), (2), and (3).

Here α is transfer latency, LS stands for Line Size, and LA indicates the average latency. The values employed here (α=6 and LS=16) are the actual values for the IBM Power3® 630 system. The time unit will be cycles.
(1) The operand “A” must come into L1 cache first.
   LA=(α+LS−1)/LS=(6+15)/16=21/16
   M*K double words are needed
   Cost for loading matrix A=LA*(M*K)
   Computational cost of using matrix A the first time=M*K*NB
   Ratio of cycle times=(M*K*NB)/(M*K*LA)=NB/LA
   Success Criterion: NB/LA [symbol] 1
(2) Column Swath of B (each swath of B uses all of A once)
   Cost of loading swath of B=LA*K*NB
   Computational cost of using matrix A with swath of B=M*K*NB
   Ratio=(M*K*NB)/(LA*K*NB)=M/LA
   Success Criterion (Ratio of cycle times): M/LA [symbol] 1
(3) Register Block of C

The two following ways i) and ii) below show at least two ways to load this block:
i) Load the C register block with 0s. Load last (extra) row of register block with C (touch). Referring to FIG. 1, after MB*NB*K FMAs (counted as cycles here), perform MB*NB adds with MB*NB elements of C (the register block). The ratio (compute cycles/load cycles)=(MB*NB*K)/(LA*MB*NB)=K/LA, and the Success Criterion: K/LA [symbol] 1
ii) Want to touch M*NB elements of C (See FIG. 1). So, M*NB/LS elements of C must be touched, and the time to load these M*NB elements is LA*M*NB. Thus, the ratio (compute cycles/load cycles)=(M*K*NB)/(LA*M*NB)=K/LA, and the Success Criterion: K/LA [symbol] 1.

Note: Both i) and ii) yield the same success criterion. The overall Success Criterion: (2) and (3) must hold simultaneously.

Details of Solution

It must be determined when the matrix (matrices) under consideration must be touched. “Touching” is a term well understood in the art as referring to accessing data in memory in anticipation of the need for that data in a process currently underway in the processor.

Consider one iteration of the inner loop in FIG. 1:
MB*NB FMAs are issued (an update to the C register block) (e.g., FPU cycles)
MB+NB loads are issued (the row/column of A/B for the rank-1 update) (e.g., load cycles)

The surplus of FPU cycles over load cycles on one pass is S=MB*NB−(MB+NB), and the surplus for all K iterations of the inner loop is K*S=K(MB*NB−(MB+NB)).

For condition (1) above, it is required that:
t_{pf} [symbol] t_{FMA}

Note: t_{pf} is the time in cycles to prefetch the data into the L1 cache; t_{FMA} is the time in cycles to perform the floating point FMAs (part of A^{T}=MB rows).

Thus,
LA*MB*KMB*NB*K or
LA [symbol] NB.

It is noted that this is the success criteria for (1). Additionally, it must be true that:
touches needed [symbol] touches available; i.e.,
   MB*K/LS [symbol] S*K
   MB/LS [symbol] S.

Conditions (2) and (3) must both hold for each time the matrix A^{T}(now in L1 cache) is reused, which is N/NB times. The success criteria for both (2) and (3) to hold simultaneously is t_{FMA}≧t_{pf}(B)+t_{pf}(C).

Recalling that t_{pf}(B)=LA*K*NB and t_{pf}(C)=LA*M*NB, success means t_{FMA}≧LA*NB(M+K).

Using t_{FMA}=M*K*NB, success means MK/(M+K)≧LA.

Also, touches needed [symbol] touches available must also hold.

The touches needed=(M+K) NB/LS and touches available=(M/MB)S*K. Thus, success here means S≧(M+K)/MK*(MB*NB)/LS.

As a specific exemplary computer configuration upon which to test the present invention, the IBM 630 Power 3® workstation has the following parameters.

For POWER3:
S=8, MB=NB=4, K=152, M=40, LS=16, and LA=21/16.
For condition (1), we need LA [symbol] NB and MB/LS [symbol] S.
Substituting in the above values, for the Power 3 gives 1.31 [symbol] 4, 0.25 [symbol] 8.
For condition (2) and (3) holding simultaneously, we need
   MK/(M+K)≧LA and S≧[(M+K)/MK][MB*NB/LS].
Substituting in the above values for POWER3, 31.67≧1.31 and 8≧(0.032)*1=0.032.

For (1) and (2) and (3) combined, the success criteria are not only satisfied, but are satisfied by a wide margin.

Therefore, all criteria are satisfied for the IBM 630 Power3®, and this shows that the invention works for this specific exemplary computer. More generally, the present invention can be implemented on any computer for which it can be demonstrated that the above criteria are satisfied.

The present invention can be considered as an example of a more general idea and can be generalized to other levels of cache, all the way to out-of-core memory. Moreover, the present invention can be combined with various of the other concepts described in the above-listed co-pending Applications to further improve linear algebra processing.

Software Product Embodiments

In addition to the hardware/software environment described above for FIG. 2, a different exemplary aspect of the invention includes a computer-implemented method for performing the invention.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 211 and hardware above, to perform the method of the invention.

This signal-bearing media may include, for example, a RAM contained within the CPU 211, as represented by the fast-access storage for example. Alternatively, the instructions may be contained in another signal-bearing media, such as a magnetic data storage diskette 500 (FIG. 5), directly or indirectly accessible by the CPU 211.

Whether contained in the diskette 500, the computer/CPU 211, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless.

The second aspect of the present invention can be embodied in a number of variations, as will be obvious once the present invention is understood. That is, the methods of the present invention could be embodied as a computerized tool stored on diskette 500 that contains a series of matrix subroutines to solve scientific and engineering problems using matrix processing in accordance with the present invention. Alternatively, diskette 500 could contain a series of subroutines that allow an existing tool stored elsewhere (e.g., on a CD-ROM) to be modified to incorporate one or more of the principles of the present invention.

The second exemplary aspect of the present invention additionally raises the issue of general implementation of the present invention in a variety of ways.

For example, it should be apparent, after having read the discussion above that the present invention could be implemented by custom designing a computer in accordance with the principles of the present invention. For example, an operating system could be implemented in which linear algebra processing is executed using the principles of the present invention.

In a variation, the present invention could be implemented by modifying standard matrix processing modules, such as described by LAPACK, so as to be based on the principles of the present invention. Along these lines, each manufacturer could customize their BLAS subroutines in accordance with these principles.

It should also be recognized that other variations are possible, such as versions in which a higher level software module interfaces with existing linear algebra processing modules, such as a BLAS or other LAPACK module, to incorporate the principles of the present invention.

Moreover, the principles and methods of the present invention could be embodied as a computerized tool stored on a memory device, such as independent diskette 500, that contains a series of matrix subroutines to solve scientific and engineering problems using matrix processing, as modified by the technique described above. The modified matrix subroutines could be stored in memory as part of a math library, as is well known in the art. Alternatively, the computerized tool might contain a higher level software module to interact with existing linear algebra processing modules.

It should also be obvious to one of skill in the art that the instructions for the technique described herein can be downloaded through a network interface from a remote storage facility.

All of these various embodiments are intended as included in the present invention, since the present invention should be appropriately viewed as a method to enhance the computation of matrix subroutines, as based upon recognizing how linear algebra processing can be more efficient by using the principles of the present invention.

In yet another exemplary aspect of the present invention, it should also be apparent to one of skill in the art that the principles of the present invention can be used in yet another environment in which parties indirectly take advantage of the present invention.

For example, it is understood that an end user desiring a solution of a scientific or engineering problem may undertake to directly use a computerized linear algebra processing method that incorporates the method of the present invention. Alternatively, the end user might desire that a second party provide the end user the desired solution to the problem by providing the results of a computerized linear algebra processing method that incorporates the method of the present invention. These results might be provided to the end user by a network transmission or even a hard copy printout of the results.

The present invention is intended to cover all these various methods of using the present invention, including the end user who uses the present invention indirectly by receiving the results of matrix processing done in accordance with the principles of the present invention.

That is, the present invention should appropriately be viewed as the concept that efficiency in the computation of matrix subroutines can be significantly improved by prefetching data to be in the L1 cache for the Level 3 BLAS kernel subroutines prior to the time that the data is actually required for the kernel calculations.

While the invention has been described in terms of a single preferred embodiment, those skilled in the art will recognize that the invention can be practiced with modification within the spirit and scope of the appended claims.

Further, it is noted that, Applicants' intent is to encompass equivalents of all claim elements, even if amended later during prosecution.

1. A method of executing a linear algebra subroutine, said method comprising:
for an execution code controlling an operation of a floating point unit (FPU) performing a linear algebra subroutine execution, unrolling instructions to prefetch data into a cache providing data into said FPU, said unrolling causing said instructions to touch data anticipated for said linear algebra subroutine execution.

2. The method of claim 1, wherein said prefetching data is accomplished by utilizing time slots caused by a difference between a time to execute instructions in said subroutine execution process and a time to load said data.

3. The method of claim 1, wherein said matrix subroutine comprises a matrix multiplication operation.

4. The method of claim 1, wherein said matrix subroutine comprises a subroutine from a LAPACK (Linear Algebra PACKage).

5. The method of claim 4, wherein said LAPACK subroutine comprises a BLAS Level 3 L1 cache kernel.

6. An apparatus, comprising:
a memory to store matrix data to be used for processing in a linear algebra program;
a floating point unit (FPU) to perform said processing;
a load/store unit (LSU) to load data to be processed by said FPU, said LSU loading said data into a plurality of floating point registers (FRegs); and
a cache to store data from said memory and provide said data to said FRegs,
wherein said matrix data in said memory is touched to be loaded into said cache prior to a need for said data to be in said FRegs for said processing.

7. The apparatus of claim 6, wherein said linear algebra program comprises a matrix multiplication operation.

8. The apparatus of claim 6, wherein said linear algebra program comprises a subroutine from a LAPACK (Linear Algebra PACKage).

9. The apparatus of claim 8, wherein said LAPACK subroutine comprises a BLAS Level 3 L1 cache kernel.

10. The apparatus of claim 6, further comprising:
a compiler to generate instructions for said touching.

11. The apparatus of claim 10, wherein instructions cause a prefetching of said data by utilizing time slots caused by a difference between a time to execute instructions in said subroutine execution process and a time to load said data.

12. A signal-bearing medium tangibly embodying a program of machine-readable instructions executable by a digital processing apparatus to perform a method of executing linear algebra subroutines, said method comprising:
for an execution code controlling an operation of a floating point unit (FPU) performing a linear algebra subroutine execution, unrolling instructions to prefetch data into a cache providing data into said FPU, said unrolling causing said instructions to touch data anticipated for said linear algebra subroutine execution.

13. The signal-bearing medium of claim 12, wherein said prefetching data is accomplished by utilizing time slots caused by a difference between a time to execute instructions in said subroutine execution process and a time to load said data.

14. The signal-bearing medium of claim 12, wherein said matrix subroutine comprises a matrix multiplication operation.

15. The signal-bearing medium of claim 12, wherein said matrix subroutine comprises a subroutine from a LAPACK (Linear Algebra PACKage).

16. The signal-bearing medium of claim 12, wherein said LAPACK subroutine comprises a BLAS Level 3 L1 cache kernel.

17. A method of providing a service involving at least one of solving and applying a scientific/engineering problem, said method comprising at least one of:
using a linear algebra software package that computes one or more matrix subroutines, wherein said linear algebra software package generates an execution code controlling an operation of a floating point unit (FPU) performing a linear algebra subroutine execution, unrolling instructions to prefetch data into a cache providing data into said FPU, said unrolling causing said instructions to touch data anticipated for said linear algebra subroutine execution;
providing a consultation for solving a scientific/engineering problem using said linear algebra software package;
transmitting a result of said linear algebra software package on at least one of a network, a signal-bearing medium containing machine-readable data representing said result, and a printed version representing said result; and
receiving a result of said linear algebra software package on at least one of a network, a signal-bearing medium containing machine-readable data representing said result, and a printed version representing said result.

18. The method of claim 17, wherein said matrix subroutine comprises a subroutine from a LAPACK (Linear Algebra PACKage).

19. The method of claim 18, wherein said LAPACK subroutine comprises a BLAS Level 3 L1 cache kernel.
